(19) United States
(12) Patent Application Publication
(10) Pub. No.: US 2025/0187596 A1
(43) Pub. Date: Jun. 12, 2025

(54) SAFETY APPARATUS AND CONTROL METHOD

(71) Applicant: TOYOTA JIDOSHA KABUSHIKI KAISHA, Toyota-shi (JP)

(72) Inventor: Kiyotaka MORIIZUMI, Nisshin-shi (JP)

(73) Assignee: TOYOTA JIDOSHA KABUSHIKI KAISHA, Toyota-shi (JP)

(21) Appl. No.: 18/946,928

(22) Filed: Nov. 14, 2024

(30) Foreign Application Priority Data
Dec. 7, 2023 (JP) 2023-207241

(51) Int. Cl. B60W 30/14; B60W 10/18; B60W 50/00

(52) U.S. Cl. CPC B60W 30/146; B60W 10/18; B60W 50/0098; B60W 2420/30; B60W 2540/223; B60W 2540/227

(57) ABSTRACT

A safety apparatus includes a controller configured to measure, using a distance sensor, a distance between a manual driving apparatus and a driver operating the manual driving apparatus while a vehicle is traveling, and transmit a deceleration stop request to the manual driving apparatus when the measured distance exceeds a threshold.

### CROSS-REFERENCE TO RELATED APPLICATION

This application claims priority to Japanese Patent Application No. 2023-207241 filed on Dec. 7, 2023, the entire contents of which are incorporated herein by reference.

### TECHNICAL FIELD

The present disclosure relates to a safety apparatus and a control method.

### BACKGROUND

Technology for driving a vehicle in a standing posture is known. For example, Patent Literature (PTL) 1 discloses a brake pedal apparatus for braking a vehicle by depressing the brake pedal while in a standing posture.

### CITATION LIST

### Patent Literature

PTL 1: JP 2012-183967 A

### SUMMARY

However, a driver driving a vehicle in a standing posture may fall over due to the swaying of the vehicle while traveling. In such cases, there is concern that the vehicle may become inoperable. Therefore, there is room for improvement with respect to technology for driving a vehicle in a standing posture.

It would be helpful to improve technology for driving a vehicle in a standing posture.

A safety apparatus according to an embodiment of the present disclosure is a safety apparatus to be mounted on a manual driving apparatus, the safety apparatus including a controller configured to:
measure, using a distance sensor, a distance between the manual driving apparatus and a driver operating the manual driving apparatus while a vehicle is traveling; and
transmit a deceleration stop request to the manual driving apparatus when the measured distance exceeds a threshold.

A control method according to an embodiment of the present disclosure is a control method performed by a safety apparatus mounted on a manual driving apparatus, the control method including:
measuring, using a distance sensor, a distance between the manual driving apparatus and a driver operating the manual driving apparatus while a vehicle is traveling; and
transmitting a deceleration stop request to the manual driving apparatus when the measured distance exceeds a threshold.

According to an embodiment of the present disclosure, technology for driving a vehicle in a standing posture is improved.

### BRIEF DESCRIPTION OF THE DRAWINGS

In the accompanying drawings:

FIG. 1 is a block diagram illustrating a schematic configuration of a vehicle according to an embodiment of the present disclosure;

FIG. 2 is a flowchart illustrating operations of a safety apparatus;

FIG. 3 is a diagram illustrating a control method using a distance sensor; and

FIG. 4 is a diagram illustrating a control method using a rope.

### DETAILED DESCRIPTION

Hereinafter, an embodiment of the present disclosure will be described.

### Outline of Embodiment

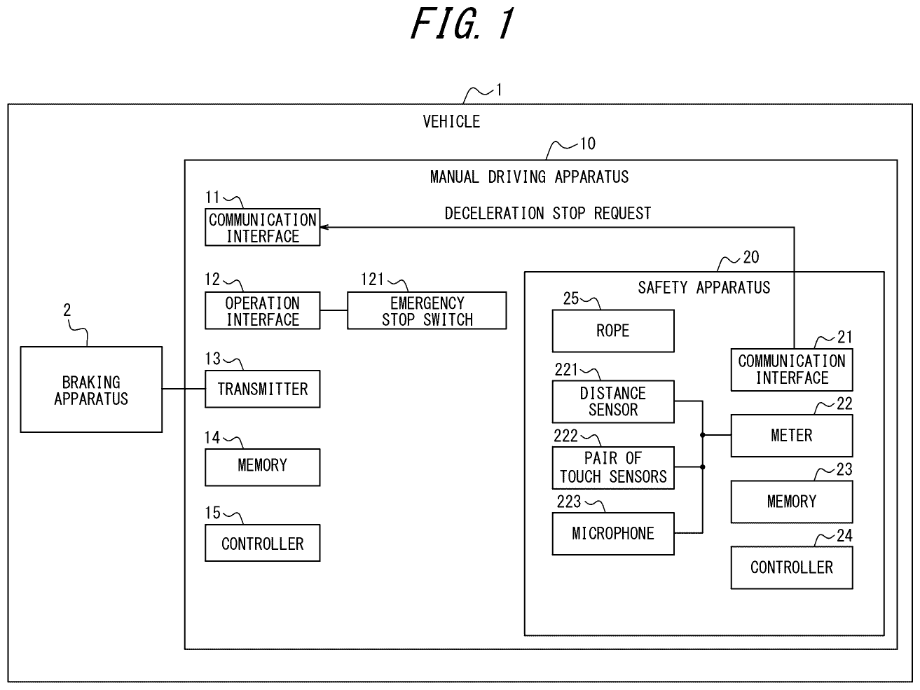

An outline of a vehicle 1 according to an embodiment of the present disclosure will be described with reference to FIG. 1. The vehicle 1 includes a braking apparatus 2, a manual driving apparatus 10, and a safety apparatus 20. The safety apparatus 20 is mounted on the manual driving apparatus 10.

The vehicle 1 is an automobile, for example, but is not limited to this and may be any appropriate vehicle. Each of the automobiles is, for example, a Battery Electric Vehicle (BEV), a Hybrid Electric Vehicle (HEV), a Plug-in Hybrid Electric Vehicle (PHEV), a Fuel Cell Electric Vehicle (FCEV), or the like, but is not limited to these. In this disclosure, vehicle 1 is described as an automated vehicle corresponding to LV4 (Level 4 automated driving). LV4 is an automated driving level where all driving operations are automated by the system under limited conditions such as location, weather, and speed. However, the vehicle 1 is not limited to the automated vehicle corresponding to LV4.

The braking apparatus 2 is an apparatus that slows or stops the vehicle 1 while the vehicle 1 is traveling or maintains the stopped state of the vehicle 1 when the vehicle 1 has already stopped.

The manual driving apparatus 10 is a portable driving device that can be installed in a vehicle 1 without a driver's seat (e.g., an automated vehicle corresponding to LV4). The manual driving apparatus 10 receives a deceleration stop request from a communication interface 21 of the safety apparatus 20 via a communication interface 11, which is wired via CAN or other means. However, the communication interface 11 and the communication interface 21 may be connected wirelessly. In response to receipt of the deceleration stop request, the manual driving apparatus 10 transmits the deceleration stop request for the vehicle 1 to the braking apparatus 2 via a transmitter 13.

The safety apparatus 20 is a computer mounted on the manual driving apparatus 10. The safety apparatus 20 is communicably connected to the communication interface 11 of the manual driving apparatus 10 via the communication interface 21 through a wired connection such as CAN. However, the communication interface 21 may be connected wirelessly to the communication interface 11.

First, an outline of the present embodiment will be described, and details thereof will be described later. The safety apparatus 20 measures, using a distance sensor 221, a distance between the manual driving apparatus 10 and the driver operating the manual driving apparatus 10 while the vehicle 1 is traveling, and transmits a deceleration stop request to the manual driving apparatus 10 when the measured distance exceeds a threshold.

Thus, according to the present embodiment, the safety apparatus 20 transmits a deceleration stop request to the manual driving apparatus 10 when the distance measured by the distance sensor 221 exceeds the threshold. Therefore, even if the driver driving the manual driving apparatus 10 falls over due to the swaying of the vehicle 1 while traveling, the safety apparatus 20 can be activated to decelerate the vehicle 1 to a stop. Thus, the technology for braking the vehicle 1 in a standing posture is improved in that the probability of avoiding an accident due to inoperability of the manual driving apparatus 10 is increased.

Next, configurations of the manual driving apparatus 10 will be described in detail.

### Configuration of Manual Driving Apparatus

As illustrated in FIG. 1, the manual driving apparatus 10 includes the communication interface 11, an operation interface 12, the transmitter 13, a memory 14, a controller 15, and the safety apparatus 20. The details of the safety apparatus 20 are described below.

The communication interface 11 includes one or more communication interfaces that provide a wired or wireless connection to the communication interface 21 of the safety apparatus 20. The communication interface is compliant with, for example, a communication standard of an in-vehicle network such as CAN, a wired local area network (LAN) standard, a wireless LAN standard, or the like, but is not limited to these, and may be compliant with any communication standard. The communication interface 11 receives a deceleration stop request for the vehicle 1 from the safety apparatus 20.

The operation interface 12 has components that can be directly operated by the driver, such as a steering wheel for turning the vehicle 1 and a brake pedal for braking (decelerating and stopping) the vehicle 1, and an emergency stop switch 121.

Upon receiving a deceleration stop request for the vehicle 1 from the brake pedal or the emergency stop switch 121 of the operation interface 12 or from the safety apparatus 20 via the communication interface 11, the transmitter 13 transmits the received deceleration stop request to the braking apparatus 2.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the manual driving apparatus 10. For example, the memory 14 may store a system program, an application program, embedded software, and the like.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire manual driving apparatus 10.

### Configuration of Safety Apparatus

As illustrated in FIG. 1, the safety apparatus 20 includes the communication interface 21, a meter 22, a memory 23, a controller 24, and a rope 25.

The communication interface 21 includes one or more communication interfaces that provide a wired or wireless connection to the communication interface 11 of the manual driving apparatus 10. The communication interface is compliant with, for example, a communication standard of an in-vehicle network such as a CAN, a wired LAN standard, or a wireless LAN standard, or the like, but is not limited to these, and may be compliant with any communication standard.

The meter 22 is equipped with the distance sensor 221, a pair of touch sensors 222, and a microphone 223. The meter 22 transmits the data measured by the distance sensor 221, the pair of touch sensors 222, and the microphone 223 to the controller 24.

The memory 23 includes one or more memories. The memories included in the memory 23 may each function as, for example, a main memory, an auxiliary memory, or a cache memory. The memory 23 stores any information to be used for operations of the safety apparatus 20. For example, the memory 23 may store a system program, an application program, a database, data measured by the meter 22, and the like.

The controller 24 includes at least one processor, at least one programmable circuit, at least one dedicated circuit, or a combination of these. The controller 24 transmits a deceleration stop request for the vehicle 1 to the manual driving apparatus 10 via the communication interface 21 based on the data measured by the meter 22. The controller 24 controls operations of the entire safety apparatus 20.

The rope 25 is a rope. In this disclosure, the rope 25 connects the clothes of a driver 3 to the emergency stop switch 121. The rope 25 is, for example, polyester rope, cotton rope, nylon rope, vinylon rope, or stainless steel wire rope, but any material is acceptable. The rope 25 should be strong enough not to break due to human walking, running or falling.

### Flow of Operations of Safety Apparatus

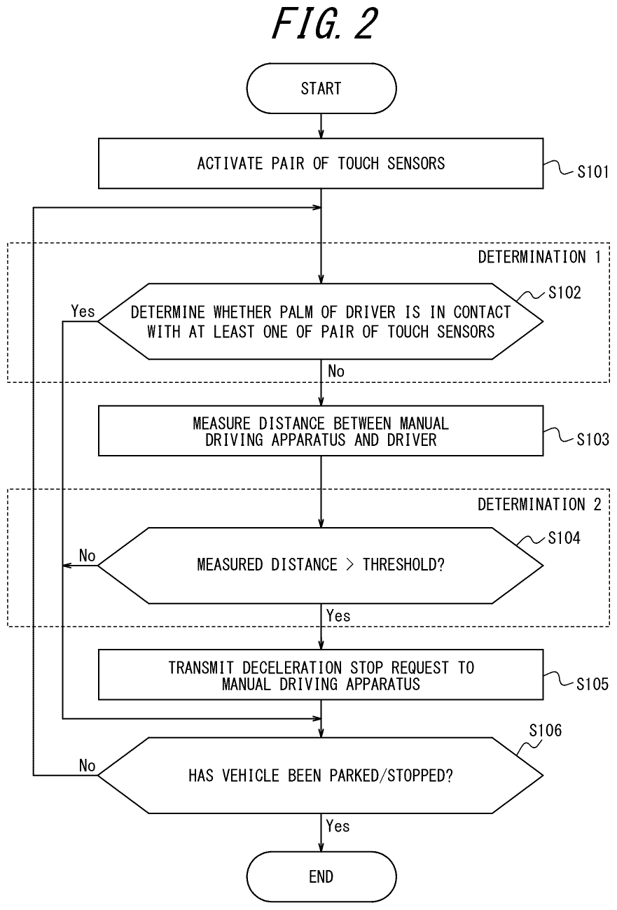

Operations of the safety apparatus 20 according to the present embodiment will be described with reference to FIG. 2. These operations relate to the transmission of a deceleration stop request to the manual driving apparatus 10.

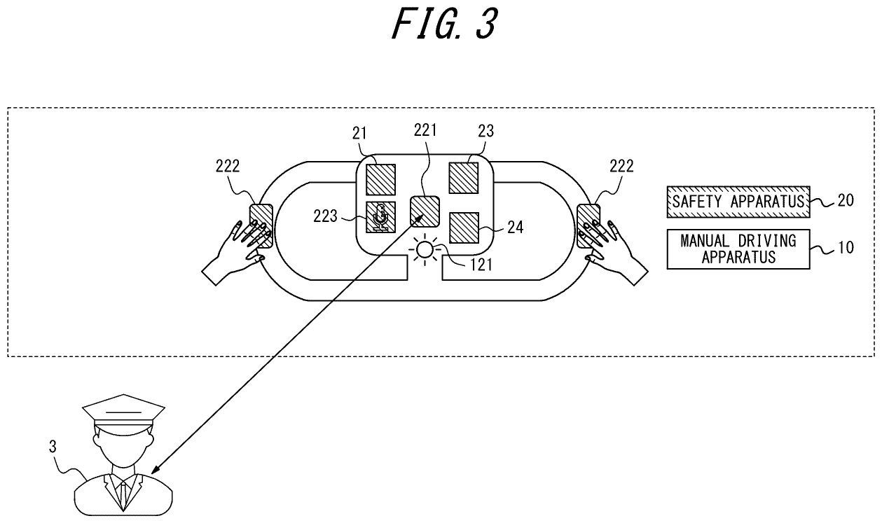

FIG. 3 illustrates the control method using the distance sensor 221. As illustrated in FIG. 3, the safety apparatus 20 includes the communication interface 21, the meter 22 (with the distance sensor 221, the pair of touch sensors 222, and the microphone 223), the memory 23, the controller 24, and the rope 25. The manual driving apparatus 10 is also equipped with the emergency stop switch 121. In this disclosure, a deceleration stop request refers to a request to slow down or pause the traveling speed of the vehicle 1 while traveling.

S101: The controller 24 activates the pair of touch sensors 222.

The safety apparatus 20 includes the pair of touch sensors 222 attached to the steering wheel of the manual driving apparatus 10 and configured to detect contact of both palms of the driver 3. When the vehicle 1 starts traveling, the controller 24 causes the meter 22 to activate the pair of touch sensors 222.

S102: The controller 24 detects whether a palm of the driver 3 is in contact with at least one of the pair of touch sensors 222. If contact is made, proceed to S106; if not, proceed to S103. The determination is referred to as determination 1.

S103: The controller 24 measures the distance between the manual driving apparatus 10 and the driver 3 operating the manual driving apparatus 10 by the distance sensor 221 while the vehicle 1 is traveling.

The meter 22 detects whether a palm of the driver 3 is in contact with at least one of the pair of touch sensors 222 and transmits the detection results to the controller 24. Upon receiving the detection results, the controller 24 determines that the driver 3 is ready to operate the manual driving apparatus 10 if a palm of the driver 3 is in contact with at least one of the pair of touch sensors 222. On the other hand, if a palm of the driver 3 has not been in contact with at least one of the pair of touch sensors 222 for a predetermined time period or longer, it becomes necessary for the controller 24 to determine whether the driver 3 is at a distance where he or she can operate the manual driving apparatus 10.

The distance sensor 221 is attached to a position facing the driver 3 who is driving the vehicle 1 in a standing posture. The attaching position is, for example, in the center of the steering wheel, as illustrated in FIG. 3, but the mounting position is not limited to this. The distance sensor 221 is, for example, a Light Detection And Ranging (LiDAR) sensor, but is not limited to this. The distance sensor 221 may be a millimeter wave sensor, an ultrasonic sensor, or a stereo camera.

The controller 24 causes the meter 22 to activate the distance sensor 221 to measure the distance between the manual driving apparatus 10 and the driver 3 when at least one of the pair of touch sensors 222 does not detect contact by a palm of the driver 3.

The controller 24 may be configured to always activate the distance sensor 221 and measure the distance between the manual driving apparatus 10 and the driver 3 while the vehicle 1 is traveling, without activating the pair of touch sensors 222 or regardless of the detection results of the pair of touch sensors 222.

S104: The controller 24 determines whether the measured distance exceeds the threshold α. If the threshold α is exceeded, proceed to S105; if the threshold α is not exceeded, proceed to S106. This determination is referred to as determination 2.

The threshold α is an upper limit of a distance between the driver 3 and the manual driving apparatus 10 that is required for the driver 3 to operate the manual driving apparatus 10. More specifically mentioned, the threshold α is the shorter of the upper limit of the distance required for the driver 3 to grip the steering wheel equipped with the pair of touch sensors 222 and the upper limit of the distance required for the driver 3 to turn on the emergency stop switch 121.

S105: The controller 24 transmits a deceleration stop request to the manual driving apparatus 10.

The manual driving apparatus 10, which receives the deceleration stop request from the controller 24 via the communication interface 11, further transmits the deceleration stop request for the vehicle 1 to the braking apparatus 2 via the operation interface 12 and the transmitter 13. The braking apparatus 2 decelerates or stops the vehicle 1 upon receiving a deceleration stop request from the manual driving apparatus 10.

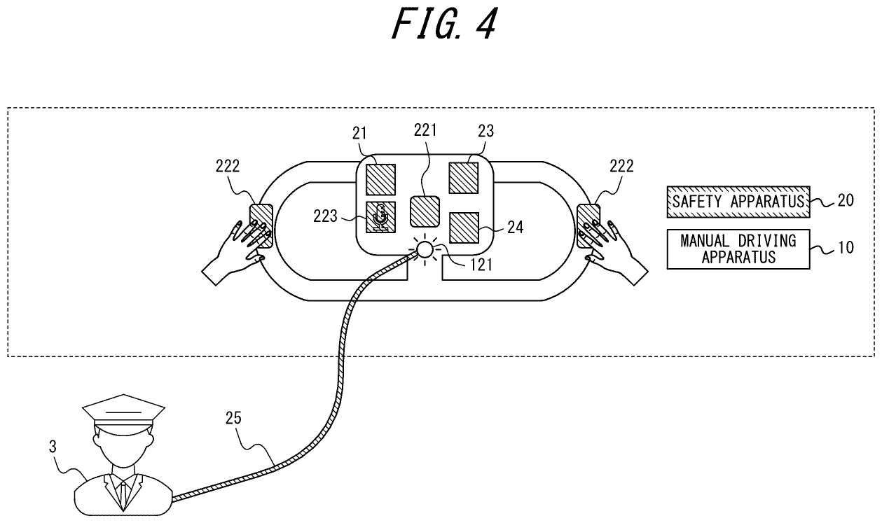

FIG. 4 illustrates the control method by the rope 25. The difference from FIG. 3 is that the clothes of the driver 3 and the emergency stop switch 121 provided in the manual driving apparatus 10 are connected by the rope 25.

As illustrated in FIG. 4, the manual driving apparatus 10 is equipped with the emergency stop switch 121. As illustrated in FIG. 4, the emergency stop switch 121 is connected to the clothes of the driver 3 by the rope 25. The length of the rope 25 may be made equivalent to the threshold α described above. The rope 25 may be configured so that the emergency stop switch 121 is turned on by a tensile force to be generated when the driver 3 moves apart from the manual driving apparatus 10 by a distance exceeding the threshold α, e.g., due to a fall. Then, when the emergency stop switch 121 is turned on, the vehicle 1 is decelerated to a stop. Such a configuration reduces the economic burden of installing expensive distance sensors 221.

S106: The controller 24 checks whether vehicle 1 has been parked/stopped. If the vehicle 1 has been parked/stopped, the information processing is terminated; if it has not been parked/stopped, it returns to S102 to continue the information processing.

Parking/stopping of the vehicle 1 means that the ignition or power switch is turned off and the vehicle 1 is parked in a stopping space or a parking space.

As described above, the safety apparatus 20 according to the present embodiment measures, using the distance sensor 221, the distance between the manual driving apparatus 10 and the driver 3 operating the manual driving apparatus 10 while the vehicle 1 is traveling, and transmits a deceleration stop request to the manual driving apparatus 10 when the measured distance exceeds the threshold α.

According to such a configuration, the safety apparatus 20 transmits a deceleration stop request to the manual driving apparatus 10 when the distance measured by the distance sensor 221 exceeds the threshold α. Therefore, even if the driver 3, who is driving the manual driving apparatus 10, falls over due to the swaying of the vehicle 1 while traveling, the vehicle 1 can be decelerated to a stop by the operation of the safety apparatus 20. Thus, the technology for driving the vehicle 1 in a standing posture is improved in that the probability of avoiding an accident due to inoperability of the manual driving apparatus 10 is increased.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

In the embodiments described above, the controller 24 described an example in which the vehicle 1 is decelerated to a stop when the distance measured by the distance sensor 221 exceeds the threshold α, or when the emergency stop switch 121 is turned on by pulling the rope 25. However, methods for decelerating the vehicle 1 to a stop are not limited to these. As illustrated in FIG. 1 and FIG. 3, the meter 22 of the safety apparatus 20 is further equipped with the microphone 223. The safety apparatus 20 may be configured so that the controller 24 transmits a deceleration stop request to the manual driving apparatus 10, for example, when the microphone 223 captures a voice such as “decelerate” or “stop” uttered by the driver 3 who has fallen over. By registering the voice of the driver 3 in advance in the memory 23 of the safety apparatus 20, it is possible to make the safety apparatus 20 respond only to the voice of the driver 3.

For example, an embodiment in which a general purpose computer functions as the safety apparatus 20 according to the above embodiment can also be implemented. Specifically, a program in which processes for realizing the functions of the safety apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A safety apparatus to be mounted on a manual driving apparatus, the safety apparatus comprising a controller configured to:
measure, using a distance sensor, a distance between the manual driving apparatus and a driver operating the manual driving apparatus while a vehicle is traveling; and
transmit a deceleration stop request to the manual driving apparatus when the measured distance exceeds a threshold.

2. The safety apparatus according to claim 1, wherein the threshold is an upper limit of a distance between the driver and the manual driving apparatus that is required for the driver to operate the manual driving apparatus.

3. The safety apparatus according to claim 1, further comprising a pair of touch sensors attached to a steering wheel of the manual driving apparatus and configured to detect contact of both palms of the driver,
wherein the controller is configured to activate the distance sensor and measure the distance between the manual driving apparatus and the driver when at least one of the pair of touch sensors does not detect contact by a palm of the driver.

4. The safety apparatus according to claim 2,
wherein the manual driving apparatus comprises an emergency stop switch, and
the safety apparatus further comprises a rope with a length equivalent to the threshold, the rope being configured to:
connect clothes of the driver and the emergency stop switch; and
turn on the emergency stop switch by a tensile force to be generated when the driver moves apart from the manual driving apparatus by a distance exceeding the threshold.

5. A control method performed by a safety apparatus mounted on a manual driving apparatus, the control method comprising:
measuring, using a distance sensor, a distance between the manual driving apparatus and a driver operating the manual driving apparatus while a vehicle is traveling; and
transmitting a deceleration stop request to the manual driving apparatus when the measured distance exceeds a threshold.
